(19) United States
(12) Patent Application Publication
(10) Pub. No.: US 2025/0247937 A1
(43) Pub. Date: Jul. 31, 2025

(54) Static Discharge System for Floor-Covering Storage and Dispensing Unit

(71) Applicant: Covermaster Inc., Toronto (CA)

(72) Inventor: Michael John DOGGETT, Derby (GB)

(73) Assignee: Covermaster Inc., Toronto, ON (CA)

(21) Appl. No.: 19/042,468

(22) Filed: Jan. 31, 2025

Related U.S. Application Data
(60) Provisional application No. 63/627,802, filed on Jan. 31, 2024.

(51) Int. Cl. H05F 3/02; B62B 3/10

(52) U.S. Cl. CPC H05F 3/02; B62B 3/104

(57) ABSTRACT

The disclosure provides solutions to mitigate discharges from electrostatic build up in floor-coverings when using a floor-covering storage and dispensing unit. Static build up occurs when two materials that are in physical contact are separated such that the materials have an excess or shortage of electrons. Static discharge is the sudden flow of electric current when differently charged materials are brought into contact or proximity. Static discharge can be uncomfortable, even dangerous, to humans, animals, and sensitive electronic equipment. Disclosed embodiments reduce or eliminate electrostatic build up within the unit by providing a permanent electrical path from the roller shafts to a frame of the unit and then to ground. Disclosed embodiments a bracket assembly, with a wiper arm that provides reliable but flexible contact with the roller shaft.

### TECHNICAL FIELD

The present invention is directed to static discharge systems, generally, and in particular, to a static discharge system for floor-covering storage and dispensing unit.

### BACKGROUND

Floor-coverings for the protection of various indoor and outdoor surfaces are known. Floor-coverings may also be provided for comfort. Such floor-coverings are commonly used to gym floors, sports arena floors, exercise studios and the like, in many, typically indoor environments.

Protective coverings for gym floors and indoor sport fields typically involve simple floor-coverings which are provided as sheets of appropriate size, made of suitable material such as plastics, which are placed atop the surface to be protected.

Floor-covering storage and dispensing units, which are typically wheeled, that are used for rolling up and storing as well as for unrolling and dispensing, such floor-coverings are also known.

Among the drawbacks of known floor-covering storage and dispensing units are ease of use, and static build up from the associated processes of rolling and unrolling the floor-coverings.

The action of rolling the floor-coverings onto the storage in these floor-covering storage and dispensing units rollers causes static charge buildup from the floor-covering sliding on the floor it is protecting.

Static charge buildup increases within the structure of the roll until the potential is so great that it tracks to earth or ground in a sudden discharge called electrostatic discharge (ESD). Electrostatic discharge refers to the sudden transfer of an electrical charge between two objects with opposite charges.

During the use of a floor-covering storage and dispensing unit, when a person comes into proximity or actual contact with the unit, he or she provides a path for rapid discharge of the accumulated charge to earth or ground, thereby resulting in an electric shock.

Static charge generation is inherent within different materials sliding across each other and cannot be eliminated. There are solutions that can be sprayed onto floors to help reduce the resistance and conductivity of the floors being covered but as soon as these wear off or the floor-covering is moved to a different location such methods of static reduction or elimination are rendered useless.

There are many publications disclosing anti-static materials and processes, including for sprays, paints, and other coatings. For instance, published patent application US201102201 discloses a transparent, electrically conductive floor care composition that uses conductive pigments. U.S. Pat. No. 4,129,505A describes an anti-static spray for clothing that uses an ethanol solution of quaternary ammonium fabric softener and ammonium acetate. U.S. Pat. No. 6,852,406B2 describes an anti-static, anti-reflection coating for a transparent substrate that uses an electrically conductive layer. U.S. Pat. No. 6,740,413B2 discusses an anti-static composition that uses a polymeric salt made of a polyoxyalkylene ammonium cation and a fluorinated anion. U.S. Pat. No. 3,048,539A teaches an anti-static textile lubricant finish. U.S. Pat. No. 5,525,261 discloses an anti-static composition and method of making it. U.S. Pat. No. 3,206,429 is directed to an improved polyethylene composition that uses N,N-diethanol oleamide for better anti-static properties.

Although the basic elements for providing anti-static materials and processes are known, improvements are desired. In particular, simple yet lasting systems to prevent or mitigate the build up of the static charges caused by the use of floor-covering storage and dispensing units are desired.

### SUMMARY OF THE DISCLOSURE

In accordance with one aspect of the present disclosure, there is provided a static discharge system for floor-covering storage and dispensing unit, the unit including: a frame; and a plurality of bearing brackets connected to the frame. The bearing brackets are for holding a roller shaft having a floor-covering attached thereon. The static discharge system includes: a roller bracket assembly having a base plate and a wiper arm connected to the base plate; and a cord in electrical communication with the roller bracket assembly providing an electrical path to electrical ground. The roller bracket assembly is affixable to each of the plurality of bearing brackets on the frame providing permanent path from the roller shaft to said electrical ground, via the wiper arm and the back plate, thereby reducing or eliminating electrostatic build up within the unit.

In accordance with another aspect of the present disclosure, there is provided a method of providing static discharge for floor-covering storage and dispensing unit, the unit having: a frame; and a plurality of bearing brackets connected to the frame for holding a roller shaft having the floor-covering attached thereon. The method includes: providing a roller bracket assembly comprising: a base plate; and a wiper arm, connected to the base plate; connecting a cord to one of the roller bracket assembly and the frame, the cord providing an electrical path to electrical ground; and affixing the roller bracket assembly to at least one of the plurality of bearing brackets on the frame such that a upon the roller shaft being placed on the bearing brackets, there is a permanent path to said electrical ground from the roller shaft, via the wiper arm and back plate, thereby reducing or eliminating electrostatic build up within the unit.

Other technical advantages may become readily apparent to one of ordinary skill in the art after review of the following figures and description.

### BRIEF DESCRIPTIONS OF THE DRAWINGS

For a better understanding of the embodiments described herein and to show more clearly how the embodiments may be carried into effect, reference will now be made, by way of example only, to the accompanying drawings in which:

FIG. 1 is a schematic perspective diagram representation of a static discharge system for floor-covering storage and dispensing unit, exemplary of an embodiment of the present invention;

FIG. 2 a perspective view of a prior art bearing bracket;

FIG. 3 a perspective view of a roller bracket assembly, forming part of the static discharge system of FIG. 1;

FIG. 4 a detailed perspective view of a roller bracket assembly of FIG. 3, depicting elements including a base plate and a wiper arm;

FIG. 5 is a top plan view of the roller bracket assembly of FIG. 3;

FIG. 6 is a left side elevational view of the roller bracket assembly of FIG. 3;

FIG. 7 is a front elevational view of the roller bracket assembly of FIG. 3;

FIG. 8 a bottom plan view of the roller bracket assembly of FIG. 3;

FIG. 9 a perspective view of the roller bracket assembly of FIG. 3, partly in cross section;

FIG. 10 a front elevational view of the roller bracket assembly of FIG. 3, partly in cross section;

FIG. 11 another perspective view of a roller bracket assembly of FIG. 3, depicting elements including a base plate and a wiper arm;

FIG. 12 is a left side elevational view of the roller bracket assembly of FIG. 11;

FIG. 13 is a front cross-section view of the roller bracket assembly of FIG. 12;

FIG. 14 is one embodiment of a base plate forming part of the roller bracket assembly of FIG. 11;

FIG. 15 is another embodiment of a base plate forming part of the roller bracket assembly of FIG. 11;

FIGS. 16-17 depict various views of nuts and bolts for use with the roller bracket assembly of FIG. 4 or FIG. 11;

FIGS. 18, 19 and 20 depict a side elevational, front elevational and perspective views of a wiper arm forming part of the roller bracket assembly of FIG. 4 or FIG. 11;

FIGS. 21, 22 and 23 depict top plan, left side elevational and perspective views of a screw for use with the roller bracket assembly of FIG. 4 or FIG. 11;

FIG. 24 is an assembled view of a roller bracket assembly of FIG. 4 or FIG. 11;

FIG. 25 is a perspective view of a wiper arm mounted to a base plate roller bracket assembly of FIG. 4 or FIG. 11, using the fastener set;

FIG. 26 is a partial perspective view of a roller bracket assembly of FIG. 4 or FIG. 11 supporting a roller shaft;

FIG. 27 is a diagram of a cable providing ground connection to discharge any electrostatic charge build up within the unit of FIG. 26; and

FIG. 28 is a diagram of a power outlet to be mounted on the frame of the unit of FIG. 26, and a power cord for providing grounded power connection to the outlet; and

FIG. 29 is a flowchart that summarizes steps of a method exemplary of an embodiment of the present invention.

Unless otherwise specifically noted, articles depicted in the drawings are not necessarily drawn to scale.

### DETAILED DESCRIPTION

Embodiments of a static discharge system for floor-covering storage and dispensing unit are disclosed. The embodiments provide a durable solution to prevent or mitigate the build up of the static charges present within rolls formed from floor-coverings, when stored in the storage and dispensing units, by providing a suitable electrical path to electrical ground thereby preventing electric shock to users that come into contact with the units, parts therefor or the rolled floor-covering stored thereon.

Directional terms such as “top,” “bottom,” “upwards,” “downwards,” “vertically,” and “laterally” are used in the following description for the purpose of providing relative reference only, and are not intended to suggest any limitations on how any article is to be positioned during use, or to be mounted in an assembly or relative to an environment. The use of the word “a” or “an” when used herein in conjunction with the term “comprising” may mean “one,” but it is also consistent with the meaning of “one or more,” “at least one” and “one or more than one.” Any element expressed in the singular form also encompasses its plural form. Any element expressed in the plural form also encompasses its singular form. The term “plurality” as used herein means more than one, for example, two or more, three or more, four or more, and the like.

In this disclosure, the terms “comprising”, “having”, “including”, and “containing”, and grammatical variations thereof, are inclusive or open-ended and do not exclude additional, un-recited elements and/or method steps. The term “consisting essentially of” when used herein in connection with a composition, use or method, denotes that additional elements, method steps or both additional elements and method steps may be present, but that these additions do not materially affect the manner in which the recited composition, method, or use functions. The term “consisting of” when used herein in connection with a composition, use, or method, excludes the presence of additional elements and/or method steps.

For clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although embodiments are illustrated in the figures and described below, the principles of the present disclosure may be implemented using any number of techniques, whether currently known or not. The present disclosure should in no way be limited to the implementations and techniques illustrated in the drawings and described in this disclosure.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or as a non-limiting example, and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

When two materials are in contact such as the gym floor and a floor-covering, electrons typically move from one material to the other, which leaves an excess of positive charge on one material, and an equal amount of negative charge on the other.

When the materials are separated, they retain this charge imbalance. A grounded outlet and the electrically conductive wire or cable can be used to provide a path to electrical ground to prevent build up of excess of positive or negative charges.

In the presence of appreciable electrical resistance between the floor-covering and electrical ground the floor-coverings accumulate and retain an electrical charge during the operation of the system. A person may experience at least a mild shock when touching the floor-covering or the floor-covering storage and dispensing unit.

Embodiments of the present invention provide a conductive path to ground for these charges thereby preventing their accumulation of charges and potential sudden discharge though a human body to earth.

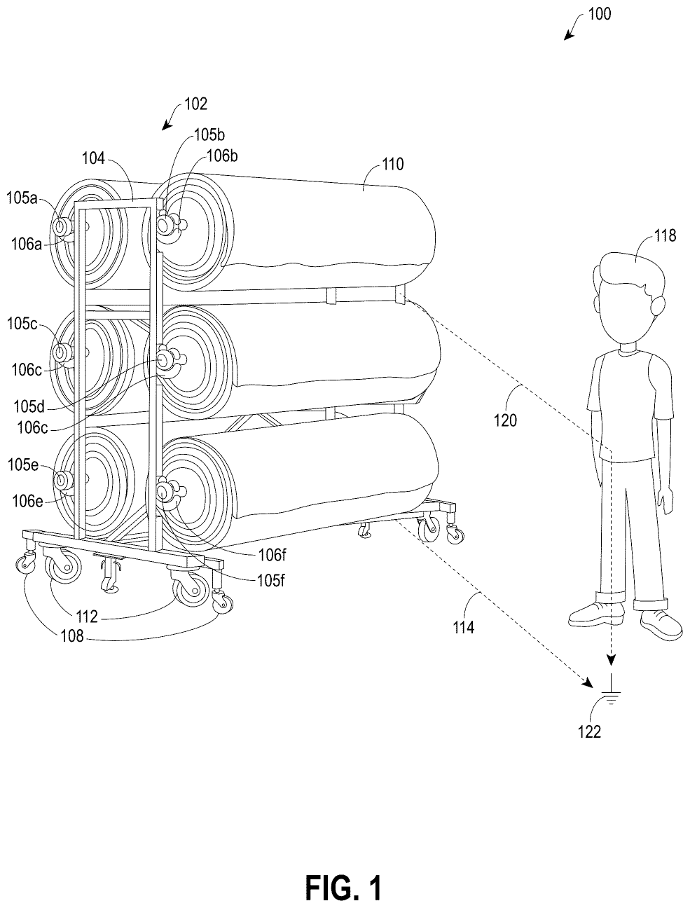

FIG. 1 is a schematic perspective diagram representation of a static discharge system 100 for a floor-covering storage and dispensing unit, exemplary of an embodiment of the present invention.

A floor-covering storage and dispensing unit 102 includes a frame 104 that provides a structure for storing rolled floor-coverings 110.

Roller shafts 105a, 105b, . . . 105f (individually and collectively “roller shafts 105”), are used to store the floor-coverings. Roller shaft storing the floor-covering 110 in a rolled-up state. Roller shafts 105 are connected to the frame 104 by a plurality of bracket assemblies 106a, 106b, . . . 106f (individually and collectively “bracket assemblies 106”).

A plurality of wheels 108, 112 are connected to a base of the frame 104. The static discharge system 100 includes pairs of roller bracket assemblies 106, each of which in turn includes several components such as a base plate 120; and a wiper arm (not specifically illustrated in FIG. 1) and fasteners that are connected to the base plate 120.

An electrical conductor in the form of a cord 114 connects to the roller bracket assembly providing an electrical path to electrical ground 122, for example, via a grounded wall outlet.

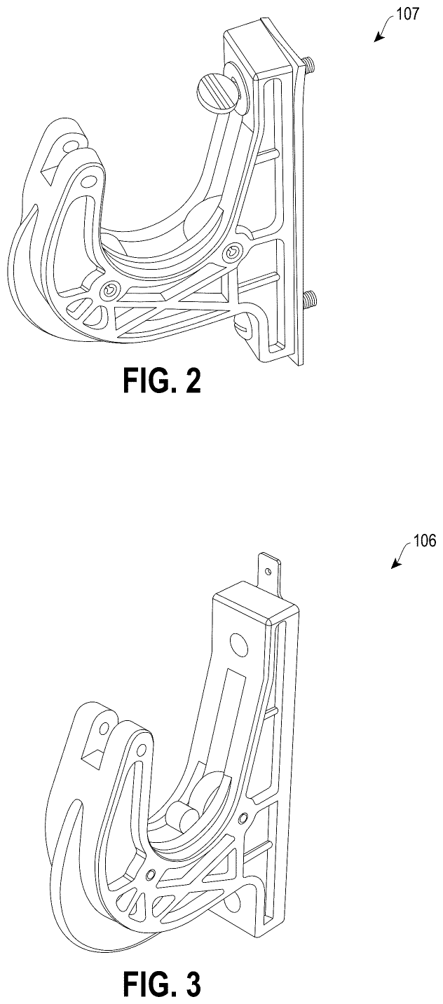

FIG. 2 a perspective view of a prior art bearing bracket 107. The prior art bearing bracket 107 does not have a base plate or a wiper arm.

Without the use of the bracket assemblies 106, a unit fitted with prior art bearing brackets such as bearing bracket 107 unfortunately provides an undesirable path 120 for accumulated charge to reach electrical ground 122 via the body of a user 118. This is sometimes known as electrostatic discharge and is highly undesirable.

Sometimes static discharge through the body of a human such as user 118 (or equivalently a pet or another animal) can be mild due to a low voltage potential caused by the charge, and in many cases the person may not even feel that a static discharge has occurred.

However, in other cases the accumulated charge and associated voltage potential can be much higher. In most such cases, the moment of discharge will cause discomfort, mild shock or unpleasant surprise. In contrast, a very high amount of discharge may cause heart fibrillation or in extreme cases, cardioversion of the heart.

Even milder static discharges are a nuisance when they occur repeatedly and may discourage a person such as the user 118 from using a piece of equipment such as the unit 102. It has been reported that at potential of 750V and 0.04 mJ can lead to a spark that is visible in darkness; a 4 KV potential at 1.2 mJ corresponds to winter doorknob spark; and that defibrillators in hospitals use considerably higher amount of joules.

As will be elaborated below, components of the roller bracket assembly 106 may be retrofitted or affixable to bearing brackets 107 on the unit 102 so as to provide a permanent path to electrical ground 122 from the roller shaft 105, via a wiper arm and back plate as will be described later, thereby reducing or eliminating electrostatic build up within the unit 102.

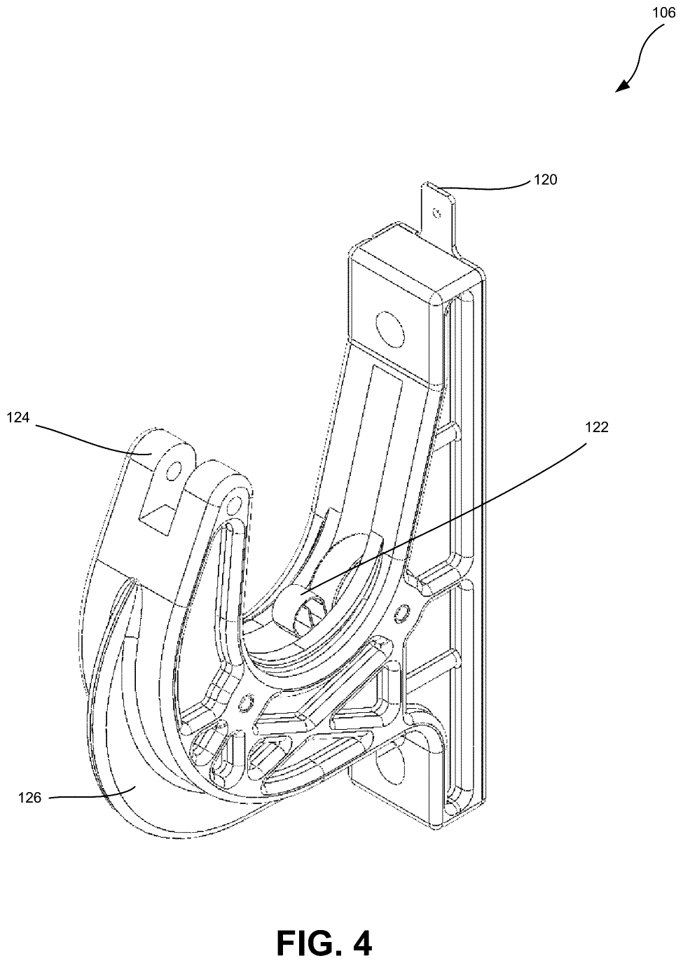

FIG. 3 a perspective view of a roller bracket assembly 106, forming part of a static discharge system exemplary of an embodiment of the present invention. FIG. 4 a detailed perspective view of a roller bracket assembly of FIG. 3, depicting constituent elements including a base plate 120 and a wiper arm 130.

The illustrated embodiment includes the use of spring steel strip material to make the conductive wiper arm 130 that could fit inside the form factor of the bearing bracket itself. Wiper arm 130 may be formed by shaping a deformable conductive strip such as metal as will be described later.

This embodiment of FIG. 3 offers many advantages including: the use of the bearing bracket for mechanical protection; elimination of finger traps; and provision of a reliable conductive connection to electrical ground (earthing) for the roller shaft. Other advantages of this embodiment include simplicity of operation, reduced cost, and ease of retrofitting into other systems.

The inventors experimented with various methods of earthing the rollers, these including the use of carbon brushes, tinned copper ribbon cable coils, and slip rings. Disadvantages of some embodiments using these experimental approaches included bulkiness requiring larger storage space beyond what cold be accommodated in discreetly with the roller shaft of the drum, trap hazards to fingers, higher cost, and reliability which are reduced or eliminated by embodiments of the present invention.

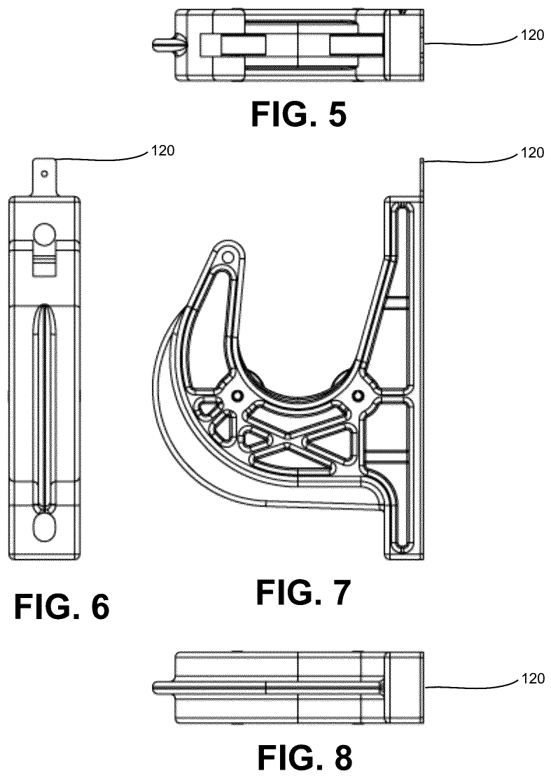

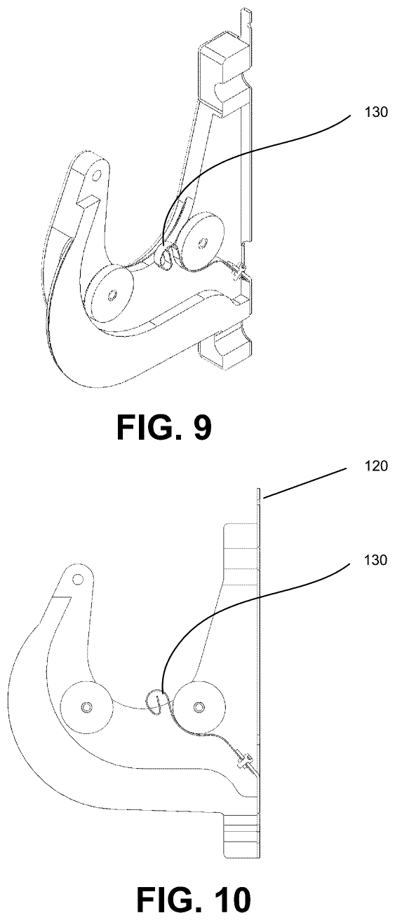

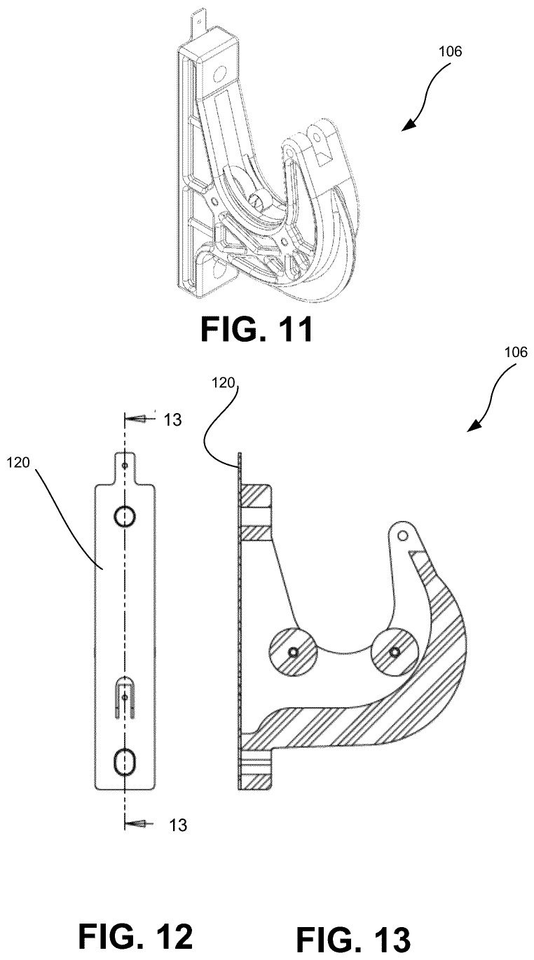

FIG. 5 is a top plan view of the roller bracket assembly of FIG. 3 in accordance with one embodiment. FIG. 6 is a left side elevational view of the roller bracket assembly of FIG. 3; while FIG. 7 is a front elevational view of the roller bracket assembly of FIG. 3; and FIG. 8 a bottom plan view of the roller bracket assembly of FIG. 3.

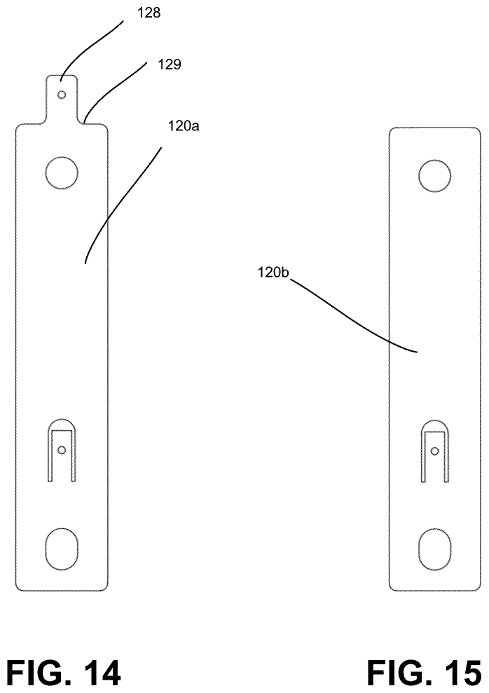

Exemplary base plates 120a and 120b (individually and collectively “base plates 120”) are illustrated in FIG. 14 and FIG. 15 respectively. Base plate 120 is designed to fit between the bearing bracket and the roller shaft. Holes formed within the base plate 120 align with the bearing brackets 107 so as to accurately position wiper arm 130 that fits discreetly between the bearing brackets 107 and roller shafts 105.

FIG. 14 depicts an embodiment of the base bracket 120a with an earthing tab 128. FIG. 15 depicts an alternative embodiment the base bracket 120b having no earthing tab.

In the embodiment of FIG. 15, physical contact between the base plate 120b and the frame 104 provides for the electrical path to ground or earth path. However, if the frame 104 was painted with a non-conductive paint or otherwise coated, then installation would require part of paint or coating work to be removed to allow a conductive electrical path to electrical ground. This is disadvantageous and adds extra cost or care to the operation.

The embodiment of FIG. 14 includes an additional feature of earthing tab 128 and a fastener to create the electrical continuity.

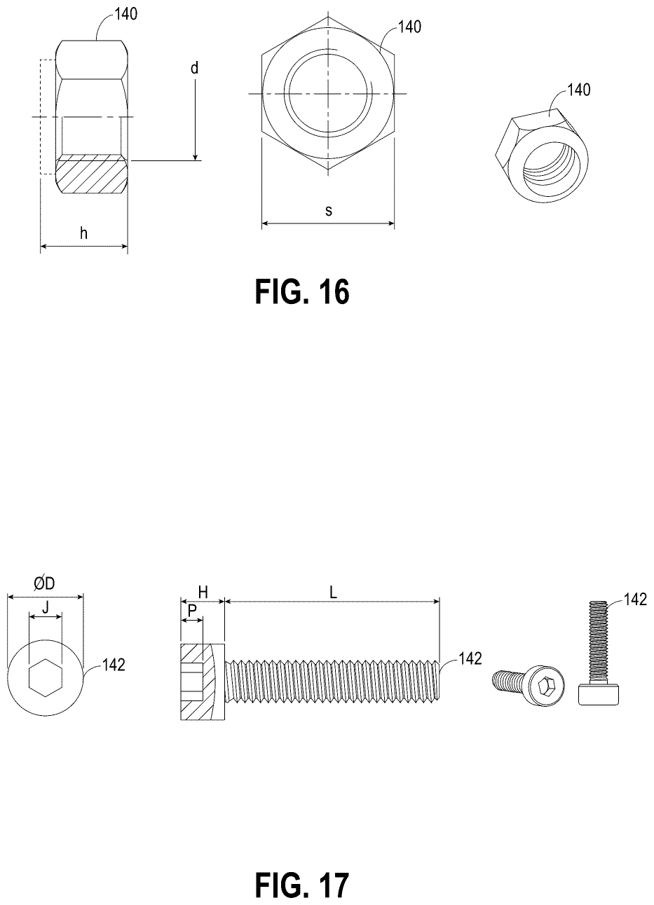

In embodiments of the present invention, the fastener is used to secure the wiper arm 130 to the base plate 120. This correctly positions the wiper arm 130 and provides continuity of the earthing circuit. In one specific embodiment, the fastener is made up of two parts that include threaded elements such as: a nut 140 (e.g., nylon antivibration nut) and a bolt 142 (or a screw such as a machine screw) as depicted in FIGS. 16 and 17 respectively. As will be appreciated by persons of skill in the art, many types of suitable fasteners may be used to secure the wiper arm 130 to the base plate 120 while ensuring electrical communication therebetween.

The dimensions depicted in FIG. 16 may be as follows: h=2.4 mm; S=5.5 mm. The dimensions depicted in FIG. 16 may be as follows: OD=5.5 mm; J=2.5 mm; H=3 mm; and L=8 mm. Tightening torque of the fastener set may be about 1.85 Nm to give mechanical strength of the joint and electrical continuity.

As noted above, the wiper arm 130 is formed from a strip of stainless spring steel. The shape of wiper arm 130 is formed to allow one or more of: (a) fit between the rollers of the bearing brackets without contact with or rubbing of the rollers; (b) make electrically conductive contact with the roller shaft 105 that needs earthing or electrical grounding; and (c) to give sufficient spring tension in an upwards direction, to contact the roller shaft 105.

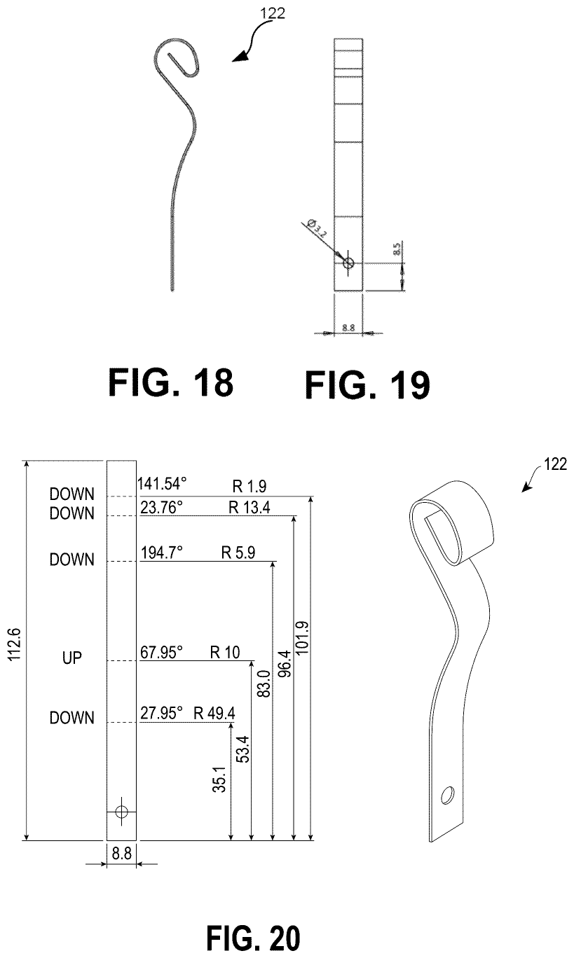

In one specific embodiment, the wiper arm 130 is manufactured from flat stainless spring steel. The wiper arm 130 is formed into a specific shape to allow fitting within the rollers of the bearing brackets. FIGS. 18-20 show the specific forming points of the flat strip to produce the required profile.

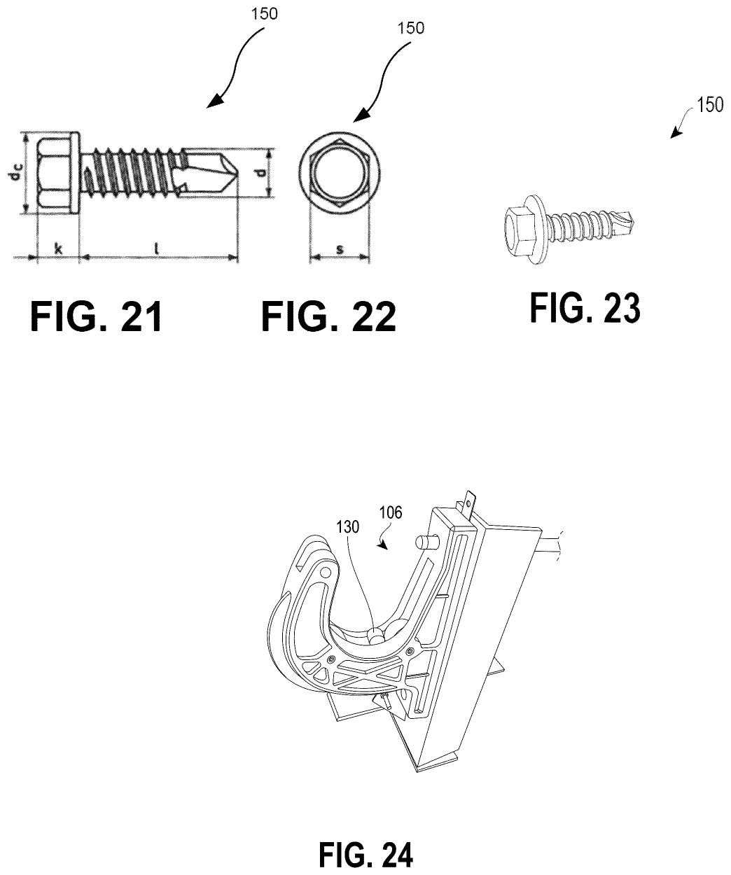

FIGS. 21, 22 and 23 depict top plan, left side elevational and perspective views of a screw 150 for use with the roller bracket assembly 106 of FIG. 4.

The earthing screw 150 in the illustrated embodiment, is a self drilling screw that creates electrical contact between the base plate 120 and the frame 104. The screw 150 is drilled into frame 104 at the correct position, as indicated by the small pilot hole 129 (see FIG. 14) in the base plate 120a. The thread on the screw 150 both secures the screw in place and makes secure contact with the metal providing the required electrical contact for earthing. This mitigates any impediments to the flow of charge due to paint or other coatings on the frame 104 or roller bracket assembly 106 and ensures electrical conductivity therebetween.

In the illustrated embodiment of FIG. 21, FIG. 22 and FIG. 23, the exemplary dimensions are: L=13 mm; Dc=10.5 mm; S=8 mm; and d=4.8 mm. In other embodiments, bolt may be used.

A roller bracket assembly such as that shown in FIG. 24 fitted to a bearing bracket, and mounted onto a test frame such as frame 102.

A roller shaft such as roller shaft 105 was positioned onto the bearing bracket 107 multiple times and the spring deviation of the wiper arm measured to ensure that the position of the wiper arm did not move. If movement was detected out of tolerance then the wiper would not contact the roller shaft and electrical conductivity may be lost. As can be seen in TABLE I, the deviation was within tolerance resulting in a pass.

TABLE I

| NUMBER OF | FORCE APPLIED | MAX | |
|---|---|---|---|
| LIFTS AND | DOWNWARDS ON | DEVIATION | RESULT |
| DROPS | THE DROP | MEASURED | (Pass |
| (No) | (KgN) | (mm) | or Fail) |
| 1 | 500 | 0 | PASS |
| 10 | 500 | 0 | PASS |
| 100 | 500 | 0.1 | PASS |
| 1000 | 500 | 0.3 | PASS |
| 2000 | 500 | 0.4 | PASS |

An electrical test was carried out to ensure that the wiper arm 130 made contact after deflection of the roller shaft 105. The earth path was measured at 1 Kv using a Megger test instrument at each interval of testing with the following results in TABLE II.

TABLE II

| | FORCE | | ELECTRICAL | |
|---|---|---|---|---|
| NUMBER | APPLIED | | RESISTANCE | |
| OF LIFTS | DOWNWARDS | | MEASURED AT | |
| AND | ON | DEVIATION | LOWERED | RESULT |
| DROPS | THE DROP | MEASURED | POSITION | (Pass |
| (No) | (KgN) | (mm) | (M Ohm) | or Fail) |
| 1 | 500 | 0 | 0 | PASS |
| 10 | 500 | 0 | 0 | PASS |
| 100 | 500 | 0.1 | 0 | PASS |
| 1000 | 500 | 0.3 | 0 | PASS |
| 2000 | 500 | 0.4 | 0 | PASS |

In operation, the base plate 120, fastener 144 (which includes nut 140 and bolt 142), and roller bracket assembly 106 with the wiper arm 130 is either retrofitted to existing frames or mounted onto new frames by a customer during installation. Each option has the same installation and implementation.

The wiper arm 130 is mounted to the base plate 120, using the fastener set of nut 140 and bolt 142, which may be tightened to 1.85 Nm to give mechanical strength to the joint and provide electrical continuity.

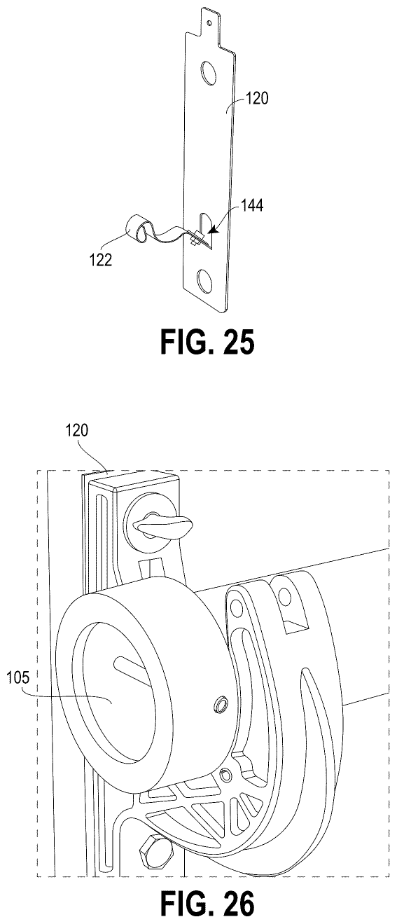

In one embodiment, the wiper arm 130 is mounted to the base plate 120 is shown in FIG. 25. In other embodiments, the wiper arm 130 and the base plate 120 may be integrally formed as a single piece. The roller bracket assembly 106 is inserted into the back or rear of a bearing bracket 107 such as that shown in FIG. 2.

The retrofitted bracket including the roller bracket assembly 106 and the bearing bracket 107 can then be secured into position on the frame 104. FIG. 26 shows the completed retrofitted bracket. The earthing screw 150 can then be drilled into position as shown in FIG. 26, to complete the earth path to the frame 104.

Bearing brackets at proximal and distal ends of a roller shaft are required in order to support a shaft on a frame. A roller bracket assembly can be added or retrofitted to just one bearing bracket at one end, or to both bearing brackets at both ends, as required by the operator. At least one roller bracket assembly is needed to be installed per roller shaft.

Embodiments of the static discharge system help stop build-up of static within each roller shaft stored or secured to the floor-covering storage and dispensing unit 102, but static could be conducted into the frame 104.

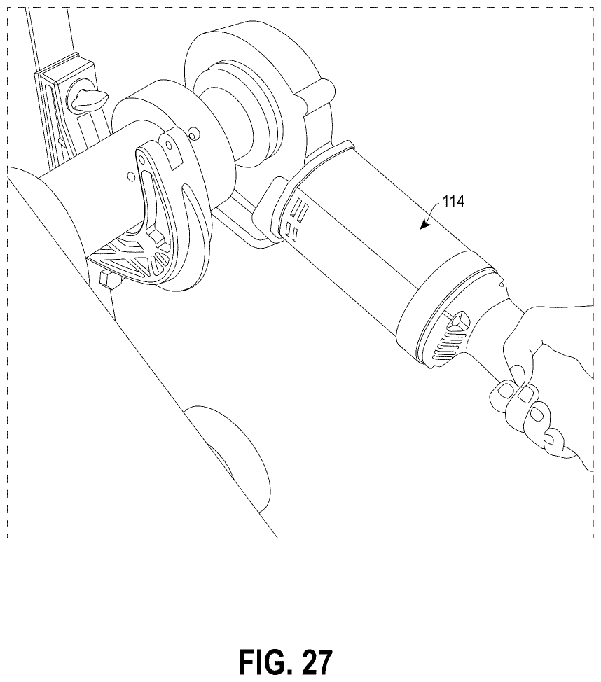

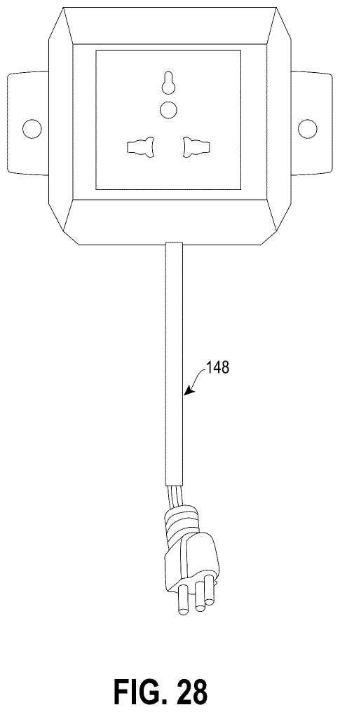

To prevent charge buildup in the unit 102, in one embodiment, the frame 104 is grounded or earthed via an electrically conductive cord 114. The cord 114 may be implemented by attaching a conductive earth strap from the frame 104 to the electrical ground 122. Alternately, the cord 114 may be in the form of direct earthing cable to the frame 104 from a suitable earth point. In yet other embodiments, the cord 114 may include a power cable 148 to a doubly insulated local power outlet mounted on the frame 104 that acts as an earthing point and can also be used to power unit 102 as shown in FIG. 27 and FIG. 28. In other words, the unit 102 includes a first local power outlet mounted to the frame 104, which is in electrical communication with a second power outlet (e.g., outlet on the wall), having a ground slot that the frame 104 is properly grounded.

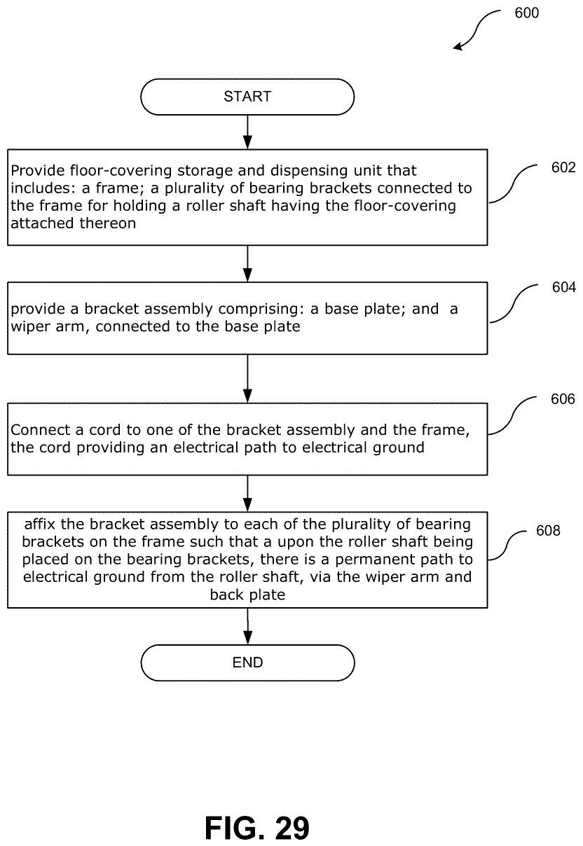

FIG. 29 depicts a flowchart 600 that summarizes steps of a method exemplary of an embodiment of the present invention, providing static discharge for floor-covering storage and dispensing unit, the unit comprising: a frame; a plurality of bearing brackets connected to the frame for holding a roller shaft having the floor-covering stored thereon in a rolled-up state.

At step 602, the method starts by providing or obtaining a floor-covering storage and dispensing unit that includes: a frame; a plurality of bearing brackets connected to the frame for holding a roller shaft having the floor-covering attached thereon.

At step 604 the method includes providing a roller bracket assembly comprising: a base plate; and a wiper arm, connected to the base plate.

At step 606 the method involves connecting a cord to one of the roller bracket assembly and the frame, the cord providing an electrical path to electrical ground.

At step 608 the method involves affixing the roller bracket assembly to each of the plurality of bearing brackets on the frame such that a upon the roller shaft being placed on the bearing brackets, there is a permanent path to electrical ground from the roller shaft, via the wiper arm and back plate, thereby reducing or eliminating electrostatic build up within the unit.

The above embodiments may be combined with one another to confer advantages that each embodiment introduces.

Although specific advantages have been enumerated above, various embodiments may include some, none, or all of the enumerated advantages.

Persons skilled in the art will appreciate that there are yet more alternative implementations and modifications possible, and that the above examples are only illustrations of one or more implementations. The scope, therefore, is only to be limited by the claims appended hereto and any amendments made thereto.

What is claimed is:

1. A static discharge system for floor-covering storage and dispensing unit, the unit comprising: a frame; and a plurality of bearing brackets connected to the frame for holding a roller shaft having a floor-covering attached thereon; the static discharge system comprising:
(a) a roller bracket assembly comprising:
(i) a base plate; and
(ii) a wiper arm, connected to the base plate; and
(b) a cord in electrical communication with the roller bracket assembly providing an electrical path to electrical ground;
wherein the roller bracket assembly is affixable to at least one of the plurality of bearing brackets on the frame providing permanent path from the roller shaft to said electrical ground, via the wiper arm and the back plate, thereby reducing or eliminating electrostatic build up within the unit.

2. The system of claim 1, further comprising an earthing screw securing the base plate to the frame.

3. The system of claim 1, further comprising a fastener securing the wiper arm to the base plate.

4. The system of claim 1, wherein the wiper arm is made of spring steel strip material.

5. The system of claim 4, wherein the wiper arm is shaped to provide spring tension in a direction towards the roller shaft thereby making contact.

6. The system of claim 5, wherein the direction is upwards.

7. The system of claim 1, wherein the unit further comprises a plurality of wheels connected to a base of the frame.

8. The system of claim 1, wherein the floor-covering attached to the roller shaft is in a rolled-up state.

9. The system of claim 1, wherein the floor-covering attached to the roller shaft is in an at least partially unrolled state.

10. The system of claim 1, further comprising a first power outlet mounted to the frame, the first power outlet connected to a second power outlet having a ground slot via another electric power cord.

11. A method of providing static discharge for floor-covering storage and dispensing unit, the unit comprising: a frame; and a plurality of bearing brackets connected to the frame for holding a roller shaft having the floor-covering attached thereon; the method comprising:
(a) providing a roller bracket assembly comprising: a base plate; and a wiper arm, connected to the base plate;
(b) connecting a cord to one of the roller bracket assembly and the frame, the cord providing an electrical path to electrical ground; and
(c) affixing the roller bracket assembly to at least one of the plurality of bearing brackets on the frame such that a upon the roller shaft being placed on the bearing brackets, there is a permanent path to said electrical ground from the roller shaft, via the wiper arm and back plate, thereby reducing or eliminating electrostatic build up within the unit.

12. The method of claim 11, further comprising using an earthing screw to secure the base plate to the frame.

13. The method of claim 11, further comprising a faster for securing the wiper arm to the base plate.

14. The method of claim 11, wherein the wiper arm is made of spring steel strip material.

15. The method of claim 14, further comprising shaping the wiper arm to provide spring tension in a direction toward the roller shaft to make contact.

16. The method of claim 11, wherein the unit comprises a plurality of wheels connected to a base of the frame, the method further comprising moving the unit.

17. The method of claim 11, wherein the floor-covering attached to the roller shaft is in a rolled-up state.

18. The method of claim 11, wherein the floor-covering attached to the roller shaft is being rolled up.

19. The method of claim 11, wherein said connecting a cord to one of the roller bracket assembly and the frame, comprises attaching a conductive strap from, one of the roller bracket assembly and the frame, to the electrical ground.
